(19) United States
(12) Patent Application Publication
(10) Pub. No.: US 2012/0296721 A1
(43) Pub. Date: Nov. 22, 2012

(54) METHOD AND SYSTEM FOR AWARDING CUSTOMER LOYALTY AWARDS

(75) Inventors: Jasper Angus Malcolmson, San Francisco, CA (US); Ashish Baldua, San Jose, CA (US); Gustavo Both Bitdinger, Chicago, IL (US); Lisa Marie Bruggeman, San Francisco, CA (US)

(73) Assignee: BLOOMSPOT, INC., San Francisco, CA (US)

(21) Appl. No.: 13/110,594

(22) Filed: May 18, 2011

(51) Int. Cl. G06Q 30/02

(52) U.S. Cl. 705/14.23; 705/14.25

(57) ABSTRACT

This invention discloses a novel system and method for implementing an electronic customer loyalty rewarding service that awards credits for continued patronage of a vendor, where the credits can be spent at the vendor or with other vendors that participate in the service.

### FIELD OF INVENTION

The invention provides a system for merchants to provide a promotional incentive to customers to initially try the services of a local merchant and to repeat usage of the merchant's services. In one embodiment, the service operates with Internet-based vendors. In another embodiment, the service operates with so-called “brick and mortar” stores using uniquely identifiable coupons. In yet another embodiment, the service is operated as a third party to the transaction between the vendor and the customer. In yet another embodiment, the service is provided to the vendor as a software product that can be operated by the vendor.

### BACKGROUND

It is well known that a vendor often rewards a customer for their own frequent purchasing or use of the vendor's goods or services. It is also known that vendors will offer a discount to a first-time customer in order to promote new business. However, there is a need for a system to offer a vendor the ability to award a customer for its initial business and repeat business, yet also use the services of a third party in order to avoid incurring its own costs of operating an automated discount program. In addition, the third party itself can provide leads for potential customers by promoting the vendor's offer of a discount to its own customers. In one embodiment of the invention, a service provider offers the customer an award as an incentive to purchase goods or services from the vendor. Thereafter, the service, by using the invention, tracks the customer's continued patronage of the vendor. As the customer reaches certain predetermined thresholds, additional awards from the service are earned and credited to the customer's account. The awards can be cash credit or non-cash credit representing the right to further discounts from the vendor. Other awards can include customer status levels as in customer service levels provided by hotels, airlines and other types of services that entitle the customer to upgrades or other types of improved accommodations. In another embodiment, the awards entitle the participating customer to discounts from other vendors associated with the service.

### DESCRIPTION OF THE FIGURES

FIG. 1. System Architecture

FIG. 2. Flow Chart with External Transaction Scanning

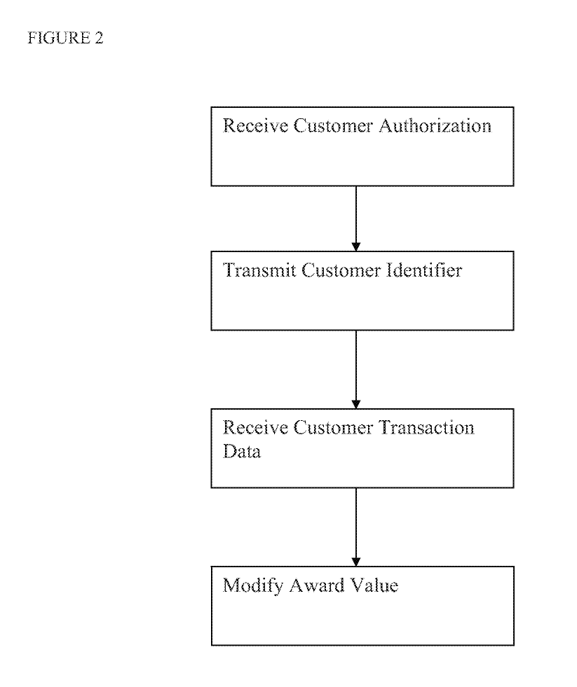

FIG. 3. Flow Chart with Internal Transaction Scanning

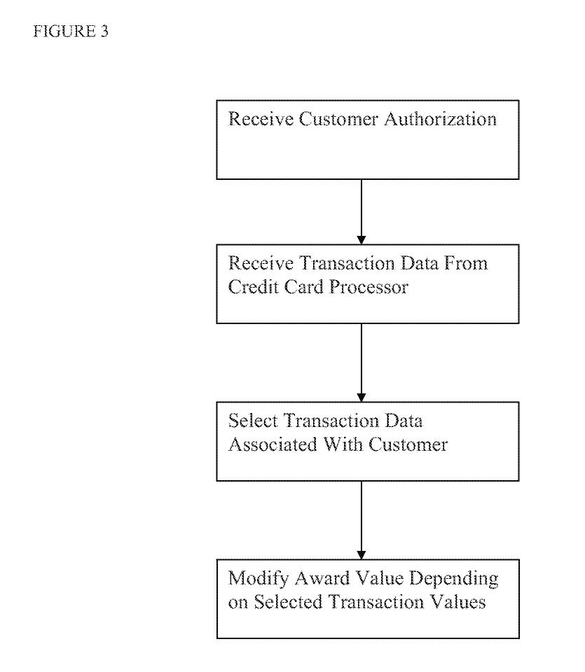

FIG. 4. Flow Chart with Broadcast Offer to Participate

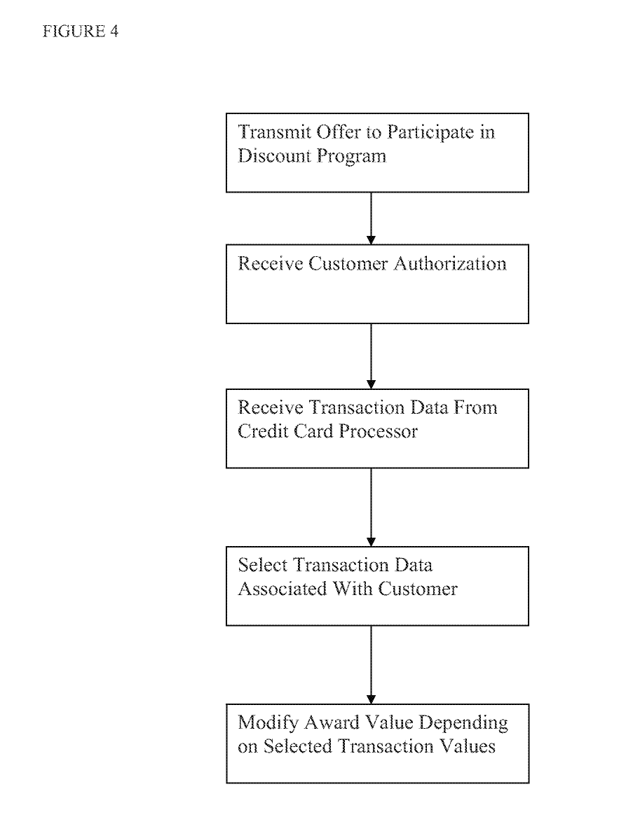

FIG. 5. Customer Data Record

### DETAILED DESCRIPTION OF THE PREFERRED EMBODIMENTS

The system operates on one or more computers, typically one or more file servers connected to the Internet. Specific embodiments for the equipment and data network are discussed below. In one embodiment, the protocol for communication is by web-page access using typical Internet protocols, or using FTP (File Transfer Protocol), and the invention will be explained in that context. However, the invention is not limited to those specific communication protocols and can include any kind of data communication or messaging protocol. All that is necessary is that one computing device to transmit a data message to another computer device over some kind of data connection. A customer's computer can be a personal computer, mobile phone, mobile handheld device like a Blackberry™ or iPhone™ or any other kind of computing device a user can use to send and receive data messages.

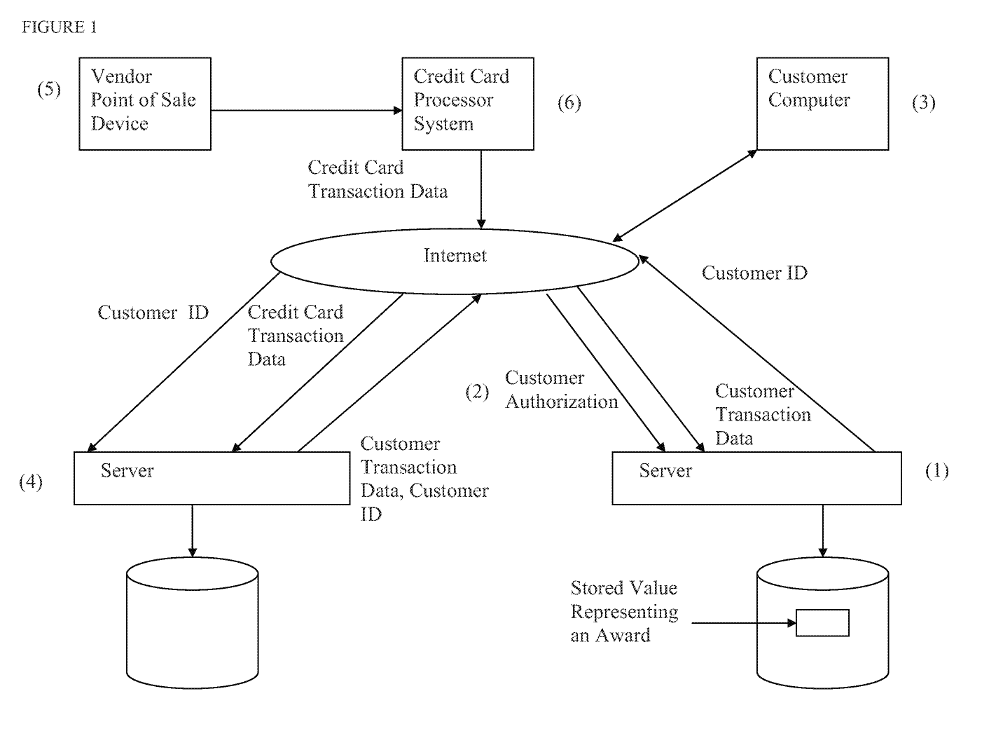

Referring now to FIG. 1, the first web-site, represented by server (1) is accessed by the customer, typically by the customer's computer device (3) accessing the first website's web-page. The customer may receive an offer to participate in the discount program that is transmitted to the customer's computer, either as an email, a webpage, a pop-up advertisement on a webpage, or as an offer displayed when the customer is buying other goods or services from the first website. At some point in the interaction, the customer authorizes the first web-site to track the customer's purchasing activity at one or more participating vendors. In one embodiment, the authorization is part of the purchasing process the customer can make for purchasing a good, service or a virtual discount coupon from the first website. For example, at the time of purchase authorization, the offer to participate in the discount program can be made with a check box on a webpage. In another embodiment, the system uses the customer's email address as the identifier. In one embodiment, the Customer ID is the last 6 digits of the customer's credit card. In one embodiment, the customer pre-purchases a coupon for obtaining goods and services from the participating one or more vendors and submits a credit card number for payment. After receiving the customer authorization (2), the first website transmits all or a subset of digits of the customer's credit card number and a Customer ID, which is a number or other alphanumeric string that is intended to be unique to the individual customer, to a service operating on a different set of servers (4). Where the Customer ID is not derived from the customer's credit card number, the credit card number or a set of such data sufficient to uniquely identify the customer's purchasing activity is also transmitted. When the customer further patronizes the participating vendor, the vendor's point of sale system (5) will send credit card transaction data, to a credit card processor (6). All of the vendor's credit card transaction data is transmitted to the second system (4) for filtering. In one embodiment, credit card transaction data comes from the vendor's credit card processor. In another embodiment, the data comes from the vendor's acquiring bank. In another embodiment, the data, comes directly from the vendor's point of sale device that accepts the credit card. In another embodiment, the data comes from the customer's credit card association, such as VISA™ or Mastercard™. In yet another embodiment, the data comes directly from the vendor through a service provided by server (1). The second system can operate as a separate service. In another embodiment, the vendor's point of sale device or the credit card processor can perform the function of filtering and therefore operates as the second system. The second system (4) filters the data to obtain the credit card transaction data associated with the Customer ID. This data is then transmitted back to the first web-site (1). In one embodiment, the raw data, is transmitted back to the first web-site. In another embodiment, the data is summarized to state the amount of money spent by a specific customer ID during a predetermined period with a particular participating vendor.

In one embodiment, the Customer ID can be associated with one credit card number or with multiple credit card numbers. The filtering service can deliver a report that cites the Customer ID for all transactions using any of the credit card numbers associated with a Customer ID. In that case, each credit card number and associated Customer ID) is delivered to the filtering service. The filtering service then maintains a database that links a Customer ID with the set of associated credit card numbers. In another embodiment, the Customer ID is a username or a randomly generated alphanumeric string that is associated by the first web-site with a username and password. The filtering service receives the Customer ID and the credit card digits to be filtered, but not the username and password. In another embodiment, the functionality of the second server is housed in the first server, such that the first website not only offers the customer the ability to participate, but also conducts the filtering function on the credit card transaction data.

At the first web-site (1), the system determines whether an award is to be made to a particular customer based on the transaction data received. In one embodiment, the system calculates the total amount spent by a particular Customer ID at a particular vendor during a pre-determined period of time. If that amount exceeds a predetermined threshold, a pre-determined award associated with that threshold for that vendor is credited to the customer. In another embodiment the pre-determined amount of time is one day. In another embodiment, the predetermined threshold is the value of the transaction amount that the customer originally paid to the first web-site for the coupon. In yet another embodiment, the award is incremented by a pre-determined percentage of each transaction with the vendor. In yet another embodiment, the award can be made based on the total amount spent by the customer on any of the participating vendors.

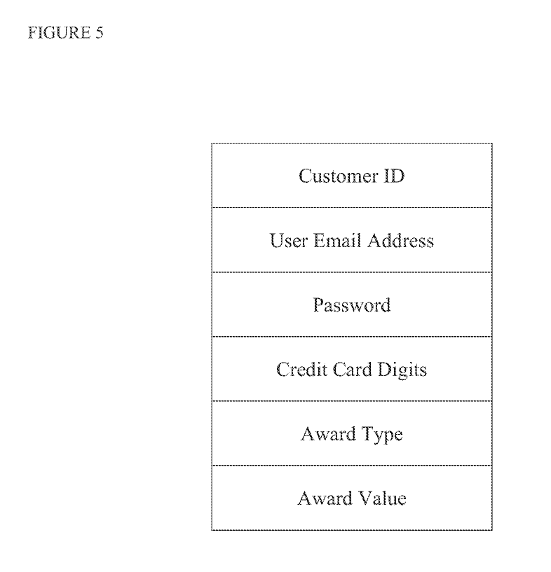

Awards can be of many types. In one embodiment, the award is a credit of monetary value that can be used for a purchase of goods or services offered from the first website. In another embodiment, the award can be a credit of monetary value that can be used to purchase goods or services from the vendor whose transactions contributed to the award. In yet another embodiment, the award can be monetary value that can be used to purchase goods or services from any vendor participating in the program that is offered through the first website. In yet another embodiment, the award can be an actual product or service, for example, an appliance, or a free massage provided by a participating vendor.

Where the award is a good or service, the award value can indicate that in the alphanumeric coding associated with the award. For example, a data record comprising the award value may have a first alphanumeric string that indicates as a logical condition whether the award is a numeric value or a product or service. If the latter, the second string is interpreted as a serial number that is associated with a product or service that is the designated award. If the former, the second string is interpreted as a numeric monetary value. This value is adjusted based on additional awards, which increment the value, or further purchases using the award, which decrement the value. If the first string indicates a status award, then the second string can represent the value of a discount that would be applied to purchases on the first website, for example, a percentage. FIG. 5 shows a typical customer data record indicating one award, represented by the two data elements award type and award value. In other embodiments, the customer data record can contain more than one award data element so that several different awards associated with several different vendors can be supported. In yet other embodiments, the data associated with the customer can be stored across multiple data records, as in a relational database where the customer ID is used as an index value.

Each participating customer is represented by a data record in a database stored and maintained by the first website. Customer ID's are stored in a database that also links the Customer ID to the award value associated with the vendor or associated with the first website.

When the system determines that the pre-determined award is to be made, the data record for that customer ID is modified to increment the amount of discount or award value associated with that customer ID. In one embodiment, the award is associated with the vendor whose patronage met the pre-determined threshold. The award serial number in the data record can be mapped to a specific vendor, or even a discount made by the vendor. In another embodiment, the award is associated with the first web-site, such that the customer can use that award as a credit with any participating vendor that accepts the first web-site's credit as a form of payment or partial payment for goods and services. In another embodiment, the amount of the award credit can be set by the vendor. For example, the vendor or the first website can set the amount of the credit to be equal to 20% of the transaction amount in excess of the value of the purchased coupon.

A customer that has an award value can use that award value to purchase goods and services from the first website. The customer can use the customer's computer to access the first website's one or more webpages. These webpages display one or more coupons or other indicia of purchase value for goods and services offered by various vendors. The customer can then purchase one or more of these coupons. During the purchase transaction, the first website displays a payment page that is transmitted to the customer's computer. That page permits the customer to select a form of payment. One of the selections can include a designation of the award value associated with the customer's Customer ID. If selected, the first website will use the indicated price of the good or service being purchased and subtract that value from the stored award value. If the price is greater than the award value, the remaining balance of the purchase price can be paid by the customer selecting a credit card or some other on-line payment system like PayPal™.

### Operating Environment:

The system is typically comprised of a central server that is connected by a data network to a user's computer. The central server may be comprised of one or more computers connected to one or more mass storage devices. A website is a central server that is connected to the Internet. The typical website has one or more files, referred to as web-pages, that are transmitted to a user's computer so that the user's computer displays an interface in dependence on the contents of the web-page file. The web-page file can contain HTML or other data that is rendered by a program operating on the user's computer. That program, referred to as a browser, permits the user to actuate virtual buttons or controls that are displayed by the browser and to input alphanumeric data. The browser operating on the user's computer then transmits values associated with the buttons or other controls and any input alphanumeric strings to the website. The website then processes these inputs, in some cases transmitting back to the user's computer additional data that is displayed by the browser. The precise architecture of the central server does not limit the claimed invention. In addition, the data, network may operate with several levels, such that the user's computer is connected through a fire wall to one server, which routes communications to another server that executes the disclosed methods. The precise details of the data network architecture does not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the customer may receive from and transmit data to the central server by means of the Internet, whereby the customer accesses an account using an Internet web-browser and browser displays an interactive webpage operatively connected to the central server. The central server transmits and receives data in response to data and commands transmitted from the browser in response to the customer's actuation of the browser user interface.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, IHTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C. C++, JAVA, or HTML) for use with various operating systems or operating environments. The source code may define and use various data structures and communication messages. The source code may be in a computer executable form (e.g., via, an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A method for tracking purchasing activity of a customer of a first website at one or more vendors comprising:
Receiving at the first web site an authorization from the customer;
Transmitting one or more identifiers associated with the customer;
Receiving data representing purchase transactions made by the customer and amounts of the customer's transactions with said one or more vendors;
Modifying a value associated with the customer representing an award in dependence on the received amounts of the customer's transactions with said one or more vendors.

2. The method of claim 1 where the award value represents the identity of a product as a prize

3. The method of claim 1 where the award value represents the identity of a service as a prize.

4. The method of claim 1 where the award value represents an amount of monetary value.

5. The method of claim 1 where the award value represents a status level associated with the customer.

6. The method of claim 1 further comprising:
pre-purchasing from the first website a good or service offered by one of the one or more vendors.

7. The method of claim 6 where the award is of monetary value that can be credited toward a purchase from said one or more vendors.

8. The method of any of claims 1, 4, 5, 6 and 7 where the receiving step is replaced with the step of:
Selecting from a plurality of credit card transaction data, transaction data associated with said customer, said transaction data containing amounts paid to said one or more vendors;

9. The method of claim 1 where the transmitting step is dependent on the authorization received from said customer.

10. The method of claim 1 where the modifying step is further comprised of:
Calculating an amount equal to a pre-determined percentage of the total of the received amounts of the customer's transactions with said vendor during a pre-determined period of time and
Incrementing the value representing an award by the calculated amount.

11. The method of claim 1 where the modifying step is further comprised of:
For each of customer's transactions with said one or more vendors, calculating an amount equal to a pre-determined percentage of such transaction and
Incrementing the value representing an award by the calculated amount.

12. The method of claim 4 further comprising:
Receiving a purchase request from the customer for goods or services and applying at least a portion of the stored award value as a monetary value toward the value of the received purchase request.

13. The method of claim 1 where the award value is a monetary value that can be used as a credit toward a purchase by the customer at said one or more vendors.

14. The method of claim 4 where the predetermined percentage is 20%.

15. The method of claim 1 further comprising:
Receiving a purchase request from said customer for a good or service offered on the first website;
Deducting at least a portion of the price associated with the purchase request from the stored value representing an award.

16. The method of claim 1 where the customer identifiers are comprised of all digits or a subset of the digits making up a credit card number and a plurality of alpha-numeric characters uniquely associated with the customer on the first website.

17. The method of claim 1 where the customer identifier is a plurality of alpha-numeric characters associated with the customer.

18. The method of claim 8 where the customer identifier is associated with more than one credit card number associated with said individual customer.

19. The method of claim 1 further comprising transmitting to the customer's computer data embodying an offer to the customer to participate in a discount promotion program.

20. The method of claim 1 where the customer identifier is associated with more than one credit card number associated with said individual customer.

21. The method of any of claims 9-20 where the receiving step is replaced with the step of:
Selecting from a plurality of credit card transaction data, transaction data associated with said customer, said transaction data containing amounts paid to said one or more vendors;

22. A system comprised of a website adapted to perform any of the methods of claims 1-7 or 9-20.

23. A computer readable medium containing computer program code that when run causes the performance of any of the methods of claims 1-7 or 9-20.

24. A system comprised of a website adapted to perform the method of claim 8.

25. A computer readable medium containing computer program code that when run causes the performance of the method of claim 8.

26. A system comprised of a website adapted to perform the method of claim 21.

27. A computer readable medium containing computer program code that when run causes the performance of the method of claim 21.
